(19) United States
(12) Patent Application Publication
(10) Pub. No.: US 2026/0326514 A1
(43) Pub. Date: Oct. 22, 2026

(54) Utility Vehicle

(71) Applicant: Kubota Corporation, Osaka-shi (JP)

(72) Inventors: Katsushige Okemoto, Osaka (JP); Shota Watase, Osaka (JP)

(21) Appl. No.: 19/405,688

(22) Filed: Dec. 2, 2025

(30) Foreign Application Priority Data
Apr. 21, 2025 (JP) 2025-069373

(51) Int. Cl. B60J 1/04; B60J 10/70

(52) U.S. Cl. CPC B60J 1/04; B60J 10/70

(57) ABSTRACT

A utility vehicle includes a driver section; a windshield disposed in a front portion of the driver section; a holder frame configured to hold an outer peripheral portion of the windshield; a dam seal provided over a whole circumferential region between the outer peripheral portion of the windshield and the holder frame; and an adhesive provided over the whole circumferential region between the outer peripheral portion of the windshield and the holder frame such that the adhesive is disposed outward of the dam seal.

### CROSS-REFERENCE TO RELATED APPLICATION

This application claims priority to Japanese Patent Application No. 2025-069373 filed April 21, 2025, the disclosure of which is hereby incorporated by reference in its entirety.

### BACKGROUND OF THE INVENTION

### 1. Field of the Invention

The present invention relates to a utility vehicle including a windshield in a front portion of a driver section.

### 2. Description of Related Art

A utility vehicle is a vehicle used for multipurpose applications such as transportation of articles and recreational activities. The utility vehicle includes a frame surrounding a cabin space of a driver section and supporting a windshield. In the related art, as described in US Patent No. 8997908 (FIG. 100), a metal frame body extending along the outer peripheral portion of the windshield is provided to raise the support strength of the windshield, and the frame body is connected to the windshield by an adhesive applied thinly.

In the above configuration in the related art, it is necessary to connect the frame body to the windshield by pressing and positionally maintaining the frame body and the windshield with the adhesive applied therebetween. However, in such a configuration, the thickness of the adhesive is small, which might decrease bonding strength. Besides, since the frame body, which is a metal member, is provided close to the windshield, there is also such a disadvantage that the windshield might be damaged due to deformation of the frame body, expansion or contraction of glass by temperature change, stress caused by installation to a body of a vehicle, or the like.

### SUMMARY OF THE INVENTION

In view of the foregoing, it is demanded that the windshield be supported successfully while a decrease in durability is suppressed.

A feature configuration of a utility vehicle according to the present invention is as follows. That is, the utility vehicle includes: a driver section; a windshield disposed in a front portion of the driver section; a holder frame configured to hold an outer peripheral portion of the windshield; a dam seal provided over a whole circumferential region between the outer peripheral portion of the windshield and the holder frame; and an adhesive provided over the whole circumferential region between the outer peripheral portion of the windshield and the holder frame such that the adhesive is disposed outward of the dam seal.

In the present invention, the dam seal is provided over the whole circumferential region between the outer peripheral portion of the windshield and the holder frame. The outer peripheral portion of the windshield is connected and fixed to the holder frame by the adhesive provided over the whole circumferential region to be disposed outward of the dam seal. With such a configuration, the distance between the windshield and the holder frame is secured by the dam seal, thereby making it possible to sufficiently secure the thickness of the adhesive and improve the bonding strength of the adhesive. Besides, the windshield is apart from the holder frame in the front-rear direction of the utility vehicle. Accordingly, even if expansion, contraction, or the like is caused due to temperature changes or the like of the windshield, the adhesive absorbs its change amount, thereby making it possible to suppress breakage caused due to the contact between the windshield and the holder frame.

As a result, it is possible to suppress a decrease in durability and to support the windshield successfully.

In the present invention, the windshield may be assembled to the holder frame with the outer peripheral portion of the windshield being apart from the holder frame by a first predetermined distance in a front-rear direction of the utility vehicle.

In this configuration, the windshield is assembled to the holder frame such that the outer peripheral portion of the windshield and the holder frame are kept apart from each other by the first predetermined distance in the front-rear direction. Accordingly, it is possible to avoid errors from arising due to variation, thereby making it possible to appropriately secure the distance between the windshield and the holder frame. Even if an error arises, the error can be absorbed by the adhesive.

In the present invention, the holder frame may have a recess in which the outer peripheral portion of the windshield is fitted in a front-rear direction of the utility vehicle, and the windshield may be assembled to the holder frame such that the outer peripheral portion of the windshield is fitted in the recess to be apart from the holder frame by a second predetermined distance in a right-left direction and an up-down direction of the utility vehicle.

In this configuration, the windshield is fitted in the recess, so that a bonding portion between the outer peripheral portion of the windshield and the holder frame, which are bonded to each other by the adhesive, is covered with a projecting portion (a portion that is not recessed) of the holder frame. As a result, rainwater or the like can hardly fall on the bonding portion, thereby making it possible to improve its durability.

In addition, the windshield is assembled to the holder frame such that the outer peripheral portion of the windshield and the holder frame are kept apart from each other by the second predetermined distance in the right-left direction and in the up-down direction. Accordingly, it is possible to avoid errors from arising due to variation, thereby making it possible to appropriately secure the distance between the windshield and the holder frame.

In the present invention, the utility vehicle may further include a covering member configured to cover, from a front side, a gap between the outer peripheral portion of the windshield and the holder frame in the right-left direction and the up-down direction.

In this configuration, the gap between the outer peripheral portion of the windshield and the holder frame is covered with the cover member. As a result, rainwater or the like can hardly enter the gap, thereby making it possible to improve the durability.

In the present invention, the utility vehicle may further include a body frame configured to support the holder frame holding the windshield such that the holder frame is attachable to and detachable from the body frame.

With this configuration, the holder frame is stably supported by the body frame with the holder frame holding the windshield. In a case where the windshield is not required, the windshield and the holder frame can be easily detached from the body frame, which is convenient.

In the present invention, the utility vehicle may further include a sealing member configured to fill a gap between the holder frame and the body frame.

In this configuration, due to the buffering function of the sealing member, it is possible to avoid the holder frame and the body frame from being damaged due to contact with each other as the body of the utility vehicle vibrates. In a case where the driver section is covered with a highly-airtight cabin, the sealing member can prevent rainwater or the like from entering the gap between the holder frame and the body frame.

In the present invention, the holder frame may have a recess in which the outer peripheral portion of the windshield is fitted in a front-rear direction of the utility vehicle. The windshield may be assembled to the holder frame with the outer peripheral portion of the windshield being fitted in the recess such that the outer peripheral portion is apart from the holder frame by a first predetermined distance in the front-rear direction and by a second predetermined distance in a right-left direction and an up-down direction of the utility vehicle. The utility vehicle may further include a sealing member configured to fill a gap between the holder frame and the body frame, the sealing member being integral with a covering member configured to cover, from a front side, a gap between the outer peripheral portion of the windshield and the holder frame in the right-left direction and the up-down direction.

With this configuration, the windshield is fitted in the recess, so that the bonding portion between the outer peripheral portion of the windshield and the holder frame, which are bonded to each other by the adhesive, is covered with a projecting portion (a portion that is not recessed) of the holder frame. As a result, rainwater or the like can hardly fall on the bonding portion, thereby making it possible to improve its durability.

Besides, the windshield is assembled to the holder frame such that the outer peripheral portion of the windshield and the holder frame are kept apart from each other by the first predetermined distance in the front-rear direction and by the second predetermined distance in the right-left direction and in the up-down direction. Accordingly, it is possible to avoid errors from arising due to variation, thereby making it possible to appropriately secure appropriate distances between the windshield and the holder frame in the front-rear direction, in the right-left direction, and in the up-down direction.

Besides, a buffering function to avoid the holder frame with high rigidity and the body frame from being damaged due to contact with each other can be achieved by the sealing member. Since the covering member is formed integrally with the sealing member, it is possible to reduce assembly effort in comparison with a case where the sealing member and the covering member are formed separately.

### BRIEF DESCRIPTION OF THE DRAWINGS

FIG. 1 is an overall side view of a utility vehicle;

FIG. 2 is a perspective view illustrating an attachment and detachment state of a windshield;

FIG. 3 is an exploded perspective view of a glass unit;

FIG. 4 is a cutaway sectional view illustrating a support configuration of the windshield;

FIG. 5 is a sectional view of an essential part before the assembly of the windshield; and

FIG. 6 is a sectional view of the essential part after the assembly of the windshield.

### DESCRIPTION OF THE INVENTION

The following describes an embodiment of a utility vehicle according to the present invention with reference to the drawings. Note that the present invention is not limited to the following embodiment and can be variously modified without departing from the gist of the present invention.

In the following description, the direction of arrow F in the drawings indicates a "forward direction," the direction of arrow B indicates a "rearward direction," the direction of arrow U indicates an "upward direction," and the direction of arrow D indicates a "downward direction," unless otherwise specified.

### Overall Configuration of Utility Vehicle

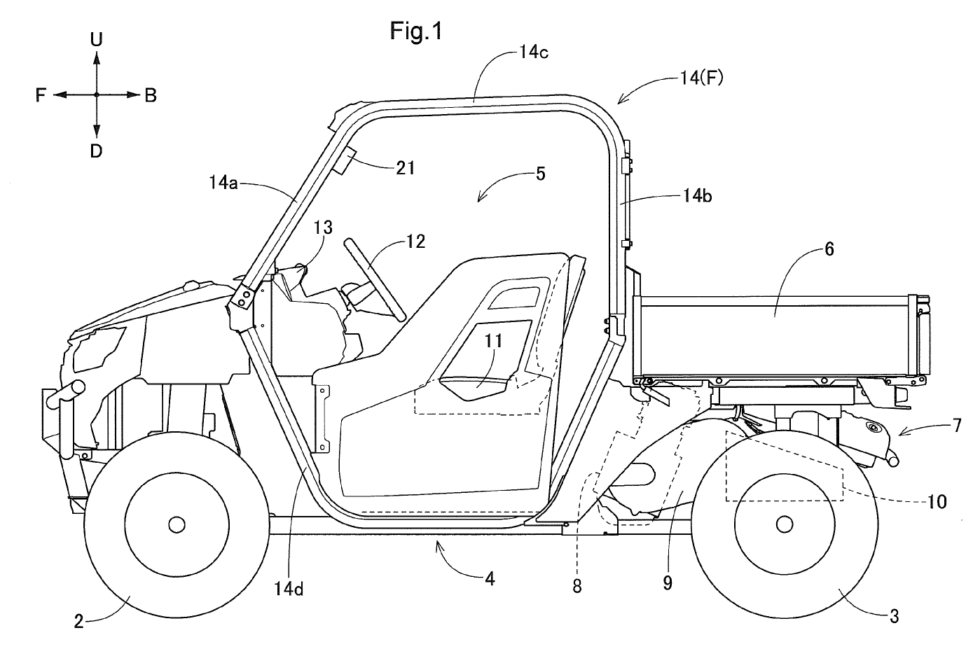

A utility vehicle illustrated in FIG. 1 is used for multipurpose applications such as transportation of articles and recreational activities. The utility vehicle includes a travel body 4 including a pair of right and left front wheels 2 steerably and drivably held by a front portion of the body, and a pair of right and left rear wheels 3 drivably held by a rear portion of the body. A driver section 5 is provided in the travel body 4 to be located between the front wheels 2 and the rear wheels 3. A loading deck 6 on which various articles can be loaded is disposed behind the driver section 5.

A motor section 7 is disposed below the loading deck 6. The motor section 7 includes an engine 8, a continuously variable transmission 9 configured to receive an output from the engine 8 and continuously vary input power, and a transmission 10 configured to receive an output from the continuously variable transmission 9, vary input power by gears, and output the power to the front wheels 2 and the rear wheels 3. The continuously variable transmission 9 is coupled to a lateral portion of the engine 8 and a lateral portion of the transmission 10. In the continuously variable transmission 9, the input power is varied by means of an endless rotation belt (not illustrated) and a belt pulley (not illustrated) changeable in winding diameter. The transmission 10 is disposed behind the engine 8.

### Driver Section

The driver section 5 includes a driver's seat 11 on which a driver sits, a steering wheel 12 disposed forward of the driver's seat 11 and configured to steer the front wheels 2, and a meter panel 13.

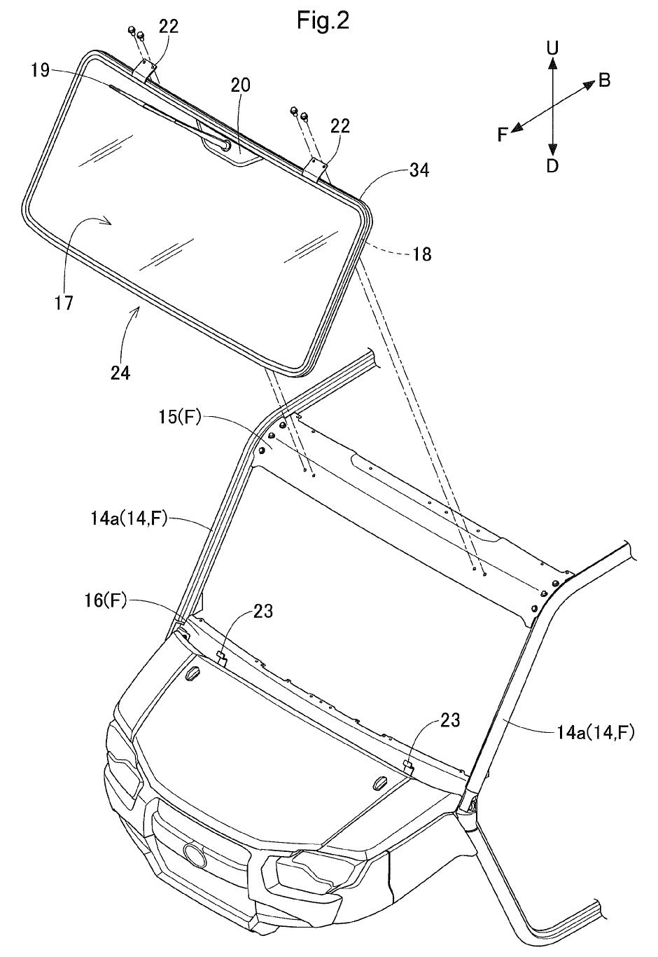

As illustrated in FIGS. 1, 2, the driver section 5 includes right and left ROPS frames 14 to protect a driver and an occupant when the travel body 4 rolls over. Each of the right and left ROPS frames 14 is made of a metal hollow tubular material and includes, in a side view, a front column support 14a disposed on the front side and inclined downward toward the front side, a rear column support 14b disposed on the rear side and extending vertically, an upper frame portion 14c disposed in a region from the upper end of the front column support 14a to the upper end of the rear column support 14b, and a lower frame 14d disposed in a region from the lower end of the front column support 14a to the lower end of the rear column support 14b. Respective upper portions of the right and left front column supports 14a are coupled to each other via a plate-shaped upper lateral frame 15, and respective lower portions of the right and left front column supports 14a are coupled to each other via a plate-shaped lower lateral frame 16.

Each of the right and left ROPS frames 14 is formed in a loop shape in a side view by coupling the lower end of the front column support 14a to the lower end of the rear column support 14b via the lower frame 14d. Hereby, the ROPS frame 14 has high strength. The ROPS frames 14 form a body frame F including the upper lateral frame 15, the lower lateral frame 16, and the like and configured to support a whole body of the utility vehicle.

### Support Structure of Windshield 17

A windshield 17 is disposed in a front portion of the driver section 5. Next will be described a support structure of the windshield 17.

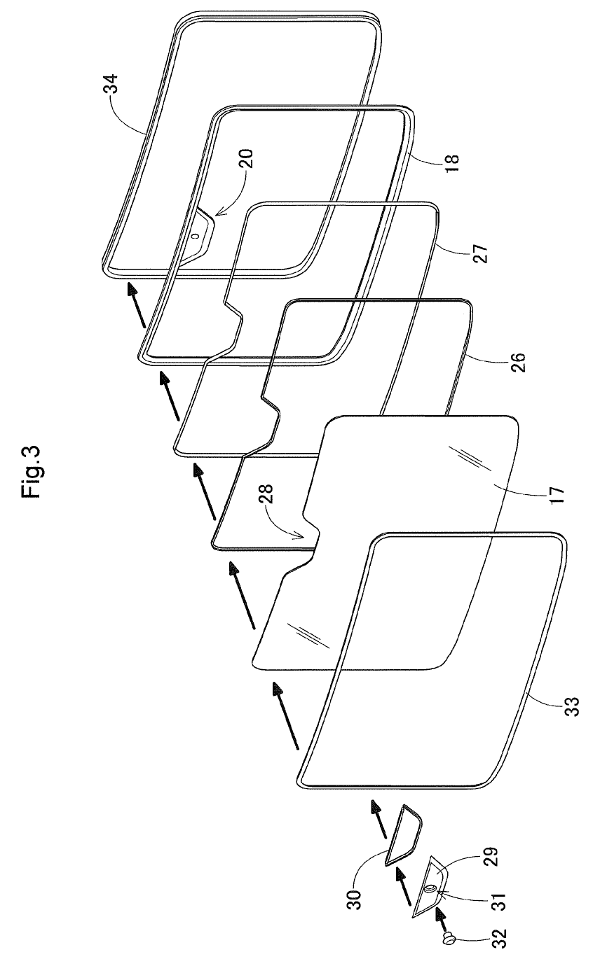

As illustrated in FIGS. 2, 3, the windshield 17 has an outer peripheral portion held by a holder frame 18 having a generally rectangular frame shape. The holder frame 18 is made of a metal material such as iron, for example, and has large strength to hold the windshield 17. A wiper support 20 configured to swingably support a wiper 19 acting on the outer surface of the windshield 17 is disposed in the center of an upper portion of the holder frame 18 in the right-left direction of the utility vehicle. A wiper motor 21 configured to drive the wiper 19 to swing is mounted on the rear side of the wiper support 20 (see FIG. 1).

The holder frame 18 is supported by the ROPS frames 14 (the body frame F) such that the holder frame 18 is attachable to and detachable from the ROPS frames 14 (the body frame F). As illustrated in FIG. 2, right and left mounting brackets 22 are disposed at an interval on the upper portion of the holder frame 18. A lower end portion of the holder frame 18 is hooked and locked from above onto right and left locking members 23 disposed at an interval on the lower lateral frame 16, and the mounting brackets 22 are coupled to the upper lateral frame 15 by bolts, so that the holder frame 18 can be supported by the ROPS frames 14 in a fixed manner. Since the holder frame 18 is fixed by the locking members 23 and the mounting brackets 22 as such, stress is not directly applied to the windshield 17. By uncoupling right and left bolts, a glass unit 24 including the windshield 17 and the holder frame 18 can be detached from the body of the utility vehicle. Even in a case where the wiper 19 and the wiper motor 21 are mounted, the glass unit 24 can be detached from the body of the utility vehicle.

The outer peripheral portion of the windshield 17 is fixed to the holder frame 18 by an adhesive provided over a whole circumferential region thereof. The adhesive layer has a predetermined thickness and has strong bonding durability. The following describes an attachment structure of the windshield 17 to the holder frame 18.

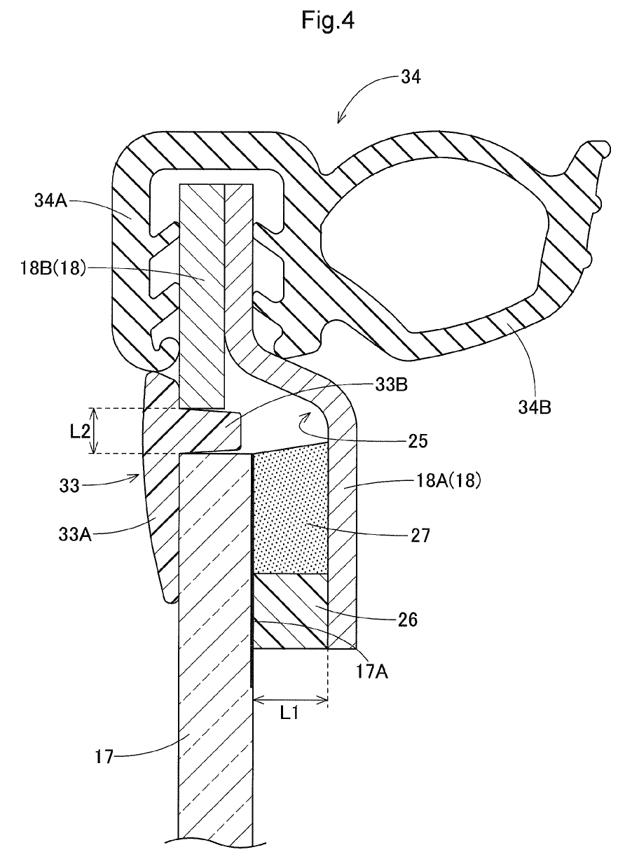

As illustrated in FIG. 4, the holder frame 18 has a recess 25 into which the outer peripheral portion of the windshield 17 is fitted rearward in the front-rear direction of the utility vehicle. The recess 25 is formed over a whole circumference of the holder frame 18. The holder frame 18 includes a main frame portion 18A having a bending shape to form the recess 25, and a plate-shaped front surface plate portion 18B located on a radially outer side of the recess 25. The front surface plate portion 18B is integrally coupled to a forward projecting portion of the main frame portion 18A. The main frame portion 18A and the front surface plate portion 18B have a gently curved shape in a plan view.

The windshield 17 is held by the holder frame 18 with the outer peripheral portion fitted in the recess 25. A dam seal 26 is provided over the whole circumferential region between the outer peripheral portion of the windshield 17 and the holder frame 18, and an adhesive 27 is provided over the whole circumferential region between the outer peripheral portion of the windshield 17 and the holder frame 18 such that the adhesive 27 is disposed outward of the dam seal 26.

As illustrated in FIG. 3, the dam seal 26 and the adhesive 27 are provided to bend along the outer edge of the wiper support 20, in an area provided with the wiper support 20. The windshield 17 has a cutout 28 in the area provided with the wiper support 20 such that the wiper support 20 is exposed forward and outward.

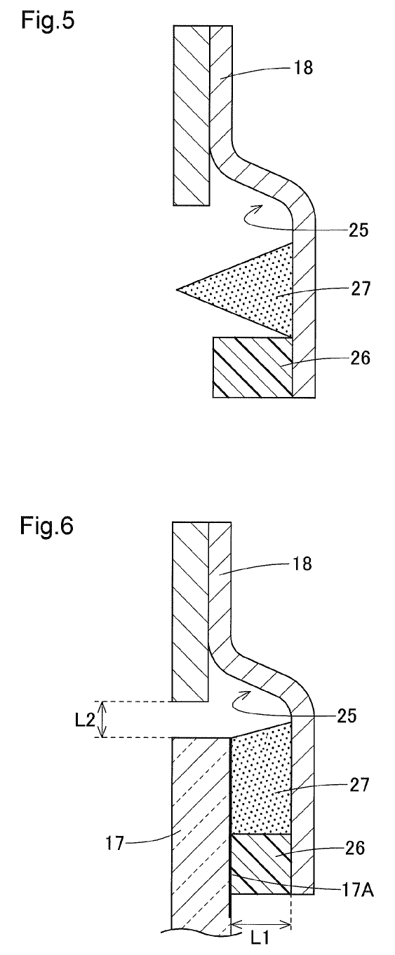

At the time when the windshield 17 is attached to the holder frame 18, the dam seal 26 is mounted between the outer peripheral portion of the windshield 17 and the holder frame 18, as illustrated in FIG. 5. The dam seal 26 is made of a high-hardness elastic material that is deformable or that can maintain a first predetermined distance L1 (described later) and is attached and fixed to the whole circumferential region along the inner circumferential end of the holder frame 18. In the case of a high-hardness elastic body, the adhesive 27 is also applied to the windshield 17, and the dam seal 26 is bonded to the windshield 17, so that the first predetermined distance L1 is easily maintained. The dam seal 26 also functions to prevent the adhesive 27 from protruding to a central portion of the windshield 17 and impairing the appearance. Subsequently, the adhesive 27 is provided over the whole circumferential region to be disposed outward of the dam seal 26 on the holder frame 18. As illustrated in FIG. 5, the adhesive 27 is applied such that the adhesive 27 has a generally triangular sectional shape. At this time, the adhesive 27 is applied in a triangular shape with the height larger than the width of the base. This allows a sufficient amount of the adhesive 27 to be applied.

Subsequently, as illustrated in FIG. 6, the windshield 17 is disposed with its outer peripheral portion fitted in the recess 25 in the front-rear direction. At this time, the windshield 17 is positioned using a jig (not illustrated) so that the outer peripheral portion of the windshield 17 is apart from the bottom surface of the recess 25 of the holder frame 18 only by the first predetermined distance L1 (for example, approximately 5 mm) in the front-rear direction, and the outer peripheral portion of the windshield 17 is apart from the front surface plate portion 18B of the holder frame 18 only by a second predetermined distance L2 (for example, approximately 3 mm) in the right-left direction and the front-rear direction. The adhesive 27 is then hardened with the windshield 17 positioned as such.

When the adhesive 27 hardens, a relative position between the windshield 17 and the holder frame 18 is determined. That is, as illustrated in FIG. 6, a separated distance, in the front-rear direction, between the outer peripheral portion of the windshield 17 and the bottom surface of the recess 25 of the holder frame 18 is set to the first predetermined distance L1. In addition, a separated distance, in the right-left direction and in the up-down direction of the utility vehicle, between the outer peripheral portion of the windshield 17 and the front surface plate portion 18B of the holder frame 18 is set to the second predetermined distance L2.

As illustrated in FIG. 3, an outer panel 29 made of a synthetic resin material is mounted to the wiper support 20 from the front side. The outer panel 29 has generally the same shape as the wiper support 20 and has an outer peripheral portion provided with a water-blocking seal 30. Although not illustrated herein, the outer panel 29 has a rear surface provided with a plurality of screw securing sections, and the outer panel 29 is fixed by using screws from behind the wiper support 20.

Each of the outer panel 29 and the wiper support 20 has an insertion hole 31 through which a drive shaft of the wiper motor 21 is to pass when the wiper 19 is mounted. In a case where the wiper 19 is not mounted, the insertion hole 31 of the outer panel 29 is closed by a cover member 32.

The windshield 17 is apart from the holder frame 18 in the right-left direction and in the up-down direction with the windshield 17 connected to the holder frame 18. In view of this, a molding 33 as a cover member for covering a gap between the windshield 17 and the holder frame 18 from the front side is mounted to fill the gap. As illustrated in FIG. 4, the molding 33 is made of an elastic material such as rubber and includes a band-shaped main portion 33A, and a ridge portion 33B for fitting, the ridge portion 33B projecting from one surface of the main portion 33A in a direction intersecting therewith. The molding 33 is mounted such that the ridge portion 33B fits in the gap between the windshield 17 and the holder frame 18, and the main portion 33A is attached and fixed to the holder frame 18 and the windshield 17. As illustrated in FIG. 4, black printing 17a is applied to the windshield 17 so that the dam seal 26 and the adhesive 27 are not observable from the front surface of the vehicle and adhesiveness with the adhesive 27 is improved.

A weather strip 34 as a sealing member that fills a gap between the holder frame 18 and the ROPS frames 14 (the body frame F) is mounted. As illustrated in FIG. 4, the weather strip 34 includes an insertion support 34A mounted to sandwich the outer peripheral portion of the holder frame 18 from both sides, and a buffering section 34B having a cavity. The insertion support 34A elastically deforms and sandwiches the outer peripheral portion of the holder frame 18 from both sides to hold the outer peripheral portion of the holder frame 18. Then, as described above, as the glass unit 24 in which the windshield 17 is assembled to the holder frame 18 is mounted to the ROPS frames 14, the buffering section 34B of the weather strip 34 elastically deforms and comes into contact with the ROPS frames 14 to fill the gap, thereby making it possible to prevent entry of water or the like.

### Alternative Embodiments

(1) In the above embodiment, the holder frame 18 has the recess 25, and the windshield 17 is assembled such that the outer peripheral portion of the windshield 17 is fitted in the recess 25. However, instead of this configuration, the holder frame 18 may have no recess.
(2) In the above embodiment, the windshield 17 is assembled to the holder frame 18 such that the outer peripheral portion of the windshield 17 is apart from the holder frame 18 by the first predetermined distance L1 in the front-rear direction. However, the present invention is not limited to this configuration, provided that the dam seal 26 is provided, and the outer peripheral portion of the windshield 17 may be apart from the holder frame 18 by an appropriate distance other than the first predetermined distance L1.
(3) In the above embodiment, the windshield 17 is assembled to the holder frame 18 such that the outer peripheral portion of the windshield 17 is apart from the holder frame 18 by the second predetermined distance L2 in the right-left direction and in the up-down direction. However, the present invention is not limited to this configuration, and the outer peripheral portion of the windshield 17 may be apart from the holder frame 18 by an appropriate distance other than the second predetermined distance L2.
(4) In the above embodiment, the molding 33 is used as a covering member. However, a trim may be provided instead of the molding 33, for example, or a covering member for covering, from the front side, a gap between the outer peripheral portion of the windshield 17 and the holder frame 18 in the right-left direction and the up-down direction may be formed integrally with the weather strip 34.
(5) In the above embodiment, the weather strip 34 is provided as a sealing member that fills a gap between the holder frame 18 and the ROPS frames 14. However, instead of the weather strip 34, other structures for sealing may be used.
(6) In the above embodiment, the holder frame 18 is supported by the ROPS frames 14 such that the holder frame 18 is attachable to and detachable from the ROPS frames 14. However, instead of this configuration, the holder frame 18 may be swingably supported by the ROPS frames 14, or the holder frame 18 may be supported by the ROPS frames 14 such that the holder frame 18 is fixed in position.

### INDUSTRIAL APPLICABILITY

The present invention is applicable to a utility vehicle including a windshield in a front portion of a driver section.

### DESCRIPTION OF THE REFERENCE NUMERALS

5: driver section

17: windshield

18: holder frame

25: recess

26: dam seal

27: adhesive

33: molding (cover member)

34: weather strip (sealing member)

F: body frame

L1: first predetermined distance

L2: second predetermined distance

What is claimed is:

1. A utility vehicle, comprising:
a driver section;
a windshield disposed in a front portion of the driver section;
a holder frame configured to hold an outer peripheral portion of the windshield;
a dam seal provided over a whole circumferential region between the outer peripheral portion of the windshield and the holder frame; and
an adhesive provided over the whole circumferential region between the outer peripheral portion of the windshield and the holder frame such that the adhesive is disposed outward of the dam seal.

2. The utility vehicle according to claim 1, wherein:
the windshield is assembled to the holder frame with the outer peripheral portion of the windshield being apart from the holder frame by a first predetermined distance in a front-rear direction of the utility vehicle.

3. The utility vehicle according to claim 1, wherein:
the holder frame has a recess in which the outer peripheral portion of the windshield is fitted in a front-rear direction of the utility vehicle, and
the windshield is assembled to the holder frame such that the outer peripheral portion of the windshield is fitted in the recess to be apart from the holder frame by a second predetermined distance in a right-left direction and an up-down direction of the utility vehicle.

4. The utility vehicle according to claim 3, further comprising:
a covering member configured to cover, from a front side, a gap between the outer peripheral portion of the windshield and the holder frame in the right-left direction and the up-down direction.

5. The utility vehicle according to claim 1, further comprising:
a body frame configured to support the holder frame holding the windshield such that the holder frame is attachable to and detachable from the body frame.

6. The utility vehicle according to claim 5, further comprising:
a sealing member configured to fill a gap between the holder frame and the body frame.

7. The utility vehicle according to claim 1, wherein:
the holder frame has a recess in which the outer peripheral portion of the windshield is fitted in a front-rear direction of the utility vehicle,
the windshield is assembled to the holder frame with the outer peripheral portion of the windshield being fitted in the recess such that the outer peripheral portion is apart from the holder frame by a first predetermined distance in the front-rear direction and by a second predetermined distance in a right-left direction and an up-down direction of the utility vehicle, and
the utility vehicle further comprises a sealing member configured to fill a gap between the holder frame and the body frame, the sealing member being integral with a covering member configured to cover, from a front side, a gap between the outer peripheral portion of the windshield and the holder frame in the right-left direction and the up-down direction.
